(19) United States
(12) Patent Application Publication
(10) Pub. No.: US 2001/0034776 A1
(43) Pub. Date: Oct. 25, 2001

(54) Digital data effect processing method for use on a network to which an effect server having data for effect processing and a user terminal having data to which an effect is to be added are connected

(76) Inventors: Toru Abe, Kanagawa-ken (JP); Toshiki Yasuda, Tokyo (JP); Yasunori Futamatsu, Tokyo (JP); Yuko Yoshie, Kanagawa-ken (JP)

Correspondence Address: NATH & ASSOCIATES, Sixth Floor, 1030 Fifteenth Street, N.W., Washington, DC, 20005, US

(21) Appl. No.: 09/834,618

(22) Filed: Apr. 16, 2001

(30) Foreign Application Priority Data
Apr. 20, 2000 (JP) P2000-120029

(51) Int. Cl. G06F 15/16

(52) U.S. Cl. 709/218; 709/203

(57) ABSTRACT

An FX server, in which an effect engine, Java applet, and effect data are stored, is connected to the Internet via a web server. A user terminal accesses the FX server via the Internet and downloads the effect engine and the Java applet to the user terminal. The Java applet starts the effect engine, which selects desired data from a plurality of effect data pieces, downloads the selected effect data, and adds an effect corresponding to the selected effect data to digital data saved on the user terminal.

### CROSS REFERENCE TO RELATED APPLICATION

This application claims benefit of priority under 35 U.S.C. §119 to Japanese Patent Application No. 2000-120029, filed on Apr. 20, 2000, the entire contents of which are incorporated by reference herein.

### BACKGROUND OF THE INVENTION

1. Field of the Invention

The present invention relates to a digital data effect processing method and a digital data effect processing system for use on a network for adding an effect via the network to digital data such as digital-camera generated data saved on a user terminal, an effect server, a user terminal, a recording medium recording therein a digital data effect processing program, and a recording medium recording therein a processing program for use on the effect server and the user terminal.

2. Description of the Related Art

For example, in the “network photo service system” disclosed in Japanese Patent Laid-Open Publication No. Hei 11-203359, the user stores digital data, such as image data, on a server on a network in advance. When using the stored digital data, the user downloads it from the network. In the “digital contents distribution system” disclosed in the Japanese Patent Laid-Open Publication No. Hei 10-302008, a data contents database and a processing scenario database are prepared in advance on a server on a network.

The prior art described above has some problems. That is, the former system requires the user to store digital data, such as image data, on a server and to download it before using it. The latter system also requires the user to download contents data and a processing scenario from the server before using them.

As described above, the conventional system requires the user, who wants to use his or her own image data over a network, to download digital data or contents from the server before processing it. At the same time, the user must install an application software program on the user terminal during off-line time. These increase the load of the user terminal.

For an application software program that processes digital data, an increased number of effect processing types increases the amount of data for various types of effect processing. This results in most of storage being used for effect processing not necessary for the user. Also, an increased amount of data for effect processing affects the speed of the application software program and therefore makes the user feel uncomfortable during execution.

### SUMMARY OF THE INVENTION

In view of the foregoing, it is an object of the present invention to provide a method for connecting, via a network server, a user terminal, with no contents effect processing program installed, to a server which has a digital data effect processing program installed thereon to allow the user terminal to selectively use data files required for processing.

It is another object of the present invention to provide a method for executing processing, which is selected via a network server, for data and contents residing on the user terminal without having to save image data in the server and download it onto the user terminal at execution time as in the conventional online image service.

It is still another object of the present invention to provide a digital data effect processing method and a digital data effect processing system for use on a network for efficiently providing a user terminal with a digital data effect processing program over the network without having to install all effect processing data on the user terminal, an effect server, a user terminal, a recording medium recording therein a digital data effect processing program for use on a network, and a recording medium recording therein a processing program for use on the effect server and the user terminal.

To achieve the above objects, there is provided a digital data effect processing method for use on a network for adding, via the network, an effect to digital data saved on a user terminal, wherein an effect server is connected to the network via a web server, the effect server comprising a processing program adding the effect to the digital data, a calling program running in a WWW browser for calling the processing program, and a plurality of effect data pieces each corresponding to one of a plurality of effect processing types, the method comprising the steps of: starting the WWW browser in the user terminal to download the processing program stored in the effect server to the user terminal via the network and the web server; reading the calling program stored in the effect server and sending the calling program to the WWW server in the user terminal; reading and starting the processing program by the calling program; selecting one of the plurality of effect data pieces by the processing program; downloading the selected effect data piece to the user terminal by the processing program: and on the user terminal, adding the effect to the digital data, to which the effect is to be added, by the processing program using the selected effect data.

The method according to the invention, unlike a conventional online image service, eliminates the need for saving image data in a server and downloading when it is needed. Instead, when adding an effect to digital data, the user selects desired effect processing via the network server with digital data on the user terminal to efficiently add an effect to digital data. The user may use a required effect function in the online mode whenever he or she requires. For example, the user may perform online image processing without having to purchase commercial image processing programs.

To achieve the above objects, there is provided a digital data effect processing system for use on a network for adding, via the network, an effect to digital data saved on a user terminal, comprising: an effect server comprising a processing program adding the effect to the digital data, a calling program running in a WWW browser for calling the processing program, and a plurality of effect data pieces each corresponding to one of a plurality of effect processing types; a web server connected to the effect server and having a WWW application providing data displayable by the WWW browser in the terminal connected via the network; and the user terminal storing therein the WWW browser and connected to the web server via the network using the WWW browser, wherein the user terminal starts the WWW browser to download the processing program stored in the effect server and, at the same time, downloads the calling program to start the processing program, and wherein the processing program selects one of the plurality of effect data pieces, downloads the selected data piece from the effect server, and adds the effect to the digital data, to which the effect is to be added, using the selected effect data.

The system according to the invention, unlike a conventional online image service, eliminates the need for saving image data in a server and downloading when it is needed. Instead, when adding an effect to digital data, the user selects desired effect processing via the network server with digital data on the user terminal to efficiently add an effect to digital data. The user may use a required effect function in the online mode whenever he or she requires. For example, the user may perform online image processing without having to purchase commercial image processing programs.

To achieve the above objects, there is provided a digital data effect processing system for use on a network, the system adding an effect, over the network, to digital data saved on a service provider terminal in response to a processing request from a user terminal, comprising: an effect server comprising a processing program adding the effect to the digital data, a calling program running in a WWW browser for calling the processing program, and a plurality of effect data pieces each corresponding to one of a plurality of effect processing types; a web server connected to the effect server and having a WWW application providing data displayable by the WWW browser in the terminal connected via the network; the service provider terminal storing therein the WWW browser and connected to the web server via the network using the WWW browser; and the user terminal sending the effect processing request to the service provider terminal via the network, wherein the service provider terminal starts the WWW browser in response to the request from the user terminal, downloads the processing program stored in the effect server, and downloads the calling program to start the processing program, and wherein the processing program selects one of the plurality of effect data pieces, downloads the selected data piece from the effect server, and adds the effect to the digital data, to which the effect is to be added, using the selected effect data.

The system according to the invention allows a service provider terminal to perform digital data processing for digital data in response to a processing request from the user terminal.

To achieve the above objects, there is provided an effect server connected to a network to which a user terminal is connected, comprising: processing program storing means for storing a processing program which will be downloaded to the user terminal by a WWW browser in the user terminal for adding an effect to digital data saved on the user terminal; calling program storing means for storing a calling program which will be downloaded to the user terminal for execution in the WWW browser in the user terminal and which calls the processing program; and effect data storing means for storing a plurality of effect data pieces each corresponding to one of a plurality of effect processing types, one of the plurality of effect data pieces being selected by the processing program and being downloaded to the user terminal.

The effect server according to the invention, which is connected to the network via the web server, stores therein the processing program, calling program, and effect data. In response to a request from the user terminal, the processing program, calling program, and effect data may be downloaded to the user terminal to add the effect, over the network, to digital data saved on the user terminal.

To achieve the above objects, there is provided a user terminal connected to a network to which an effect server is connected, comprising: digital data storing means for storing digital data to which an effect is to be added; a WWW browser which downloads a processing program stored in the effect server and adding the effect to the digital data and which reads a calling program stored in the effect server to call and start the processing program; and processing control means for selecting, by the processing program, one of a plurality of effect data pieces each corresponding to one of a plurality of effect processing types, for downloading the selected effect data piece, and for adding the effect to the digital data, to which the effect is to be added, using the selected effect data piece.

The user terminal according to the invention may download desired data from the effect server via the network and add an effect corresponding to the selected effect data to digital data saved on the user terminal.

To achieve the above objects, there is provided a recording medium recording therein an effect processing program for use on a network for adding, via the network, an effect to digital data saved on a user terminal, wherein the program causes a computer to: start a WWW browser stored in the user terminal and connect the WWW browser, via the network, to a web server to which an effect server is connected, the effect server comprising a processing program adding the effect to the digital data, a calling program running in the WWW browser for calling the processing program, and a plurality of effect data pieces each corresponding to one of a plurality of effect processing types; download the processing program stored in the effect server to the user terminal via the network and the web server; read the calling program stored in the effect server and send the calling program to the WWW browser in the user terminal; read the processing program by the calling program to start the processing program; select one of the plurality of effect data pieces by the processing program; download the selected effect data piece to the user terminal by the processing program; and add, on the user terminal, the effect to the digital data by the processing program using the selected effect data piece.

The recording medium according to the invention contains the digital data effect processing program adding, over the network, an effect corresponding to the selected effect data to digital data. Therefore, the recording medium makes it easy to distribute the program.

To achieve the above objects, there is provided a recording medium recording therein an effect processing program for use in an effect server connected to a network to which a user terminal is connected, wherein the program causes a computer to: download a processing program to the user terminal via the network in response to a request from the user terminal, the processing program adding an effect to digital data; send a calling program to a WWW browser stored in the user terminal in response to a request from the user terminal, the calling program running in the WWW browser and calling the processing program; and download one of a plurality of effect data pieces, each corresponding to one of a plurality of effect processing types, to the user terminal according to a selection made by the processing program on the user terminal.

The recording medium according to the invention contains the processing program for use in the effect server which is connected to the network and which stores therein the processing program adding an effect to digital data and a plurality of effect data pieces each corresponding to one of a plurality of effect processing types. In response to an effect processing request from the user terminal, the program and the data may be downloaded to the user terminal. Therefore, the recording medium makes it easy to distribute the program.

To achieve the above objects, there is provided a recording medium recording therein an effect processing program for use on a user terminal connected to a network to which an effect server is connected, wherein the program causes a computer to: start a WWW browser and download a processing program via the network, the processing program being stored in the effect server and adding an effect to digital data; read a calling program and receive the calling program in the WWW browser, the calling program being stored in the effect server and running in the WWW browser to call the processing program; read and start the processing program by the calling program; select one of a plurality of effect data pieces by the processing program, the plurality of effect data pieces being stored in the effect server and each of the plurality of effect data pieces corresponding to one of a plurality of effect types; download the selected effect data piece from the effect server by the processing program; and add the effect to the digital data, to which the effect is to be added, by the processing program using the selected effect data piece.

The recording medium according to the invention contains the processing program adding an effect to digital data saved on the user terminal using desired effect data downloaded from the effect server via the network. Therefore, the recording medium makes it easy to distribute the program.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a diagram showing the configuration of a system that executes, in a network, a digital data effect processing method used in an embodiment according to the present invention.

FIG. 2 is a diagram showing the basic processing flow in the digital data effect processing system shown in the embodiment shown in FIG. 1.

FIG. 3 is a sequence diagram showing a part the operation of the digital data effect processing system in the embodiment shown in FIG.1.

FIG. 4 is a sequence diagram showing a part the operation, following that shown in FIG. 3, of the digital data effect processing system in the embodiment shown in FIG. 1.

FIG. 5 is a sequence diagram showing a part the operation, following that shown in FIG. 4, of the digital data effect processing system in the embodiment shown in FIG. 1.

FIG. 6 is a flowchart showing the entire operation of the digital data effect processing system in the embodiment shown in FIG. 1.

FIG. 7 is a diagram showing an example of the service of the digital data effect processing system in the embodiment shown in FIG. 1.

FIG. 8 is a diagram showing an example of the effect thumbnail screen of the digital data effect processing system in the embodiment shown in FIG. 1.

FIG. 9 is a diagram showing another example of the effect thumbnail screen of the digital data effect processing system in the embodiment shown in FIG. 1.

### DESCRIPTION OF THE PREFERRED EMBODIMENTS

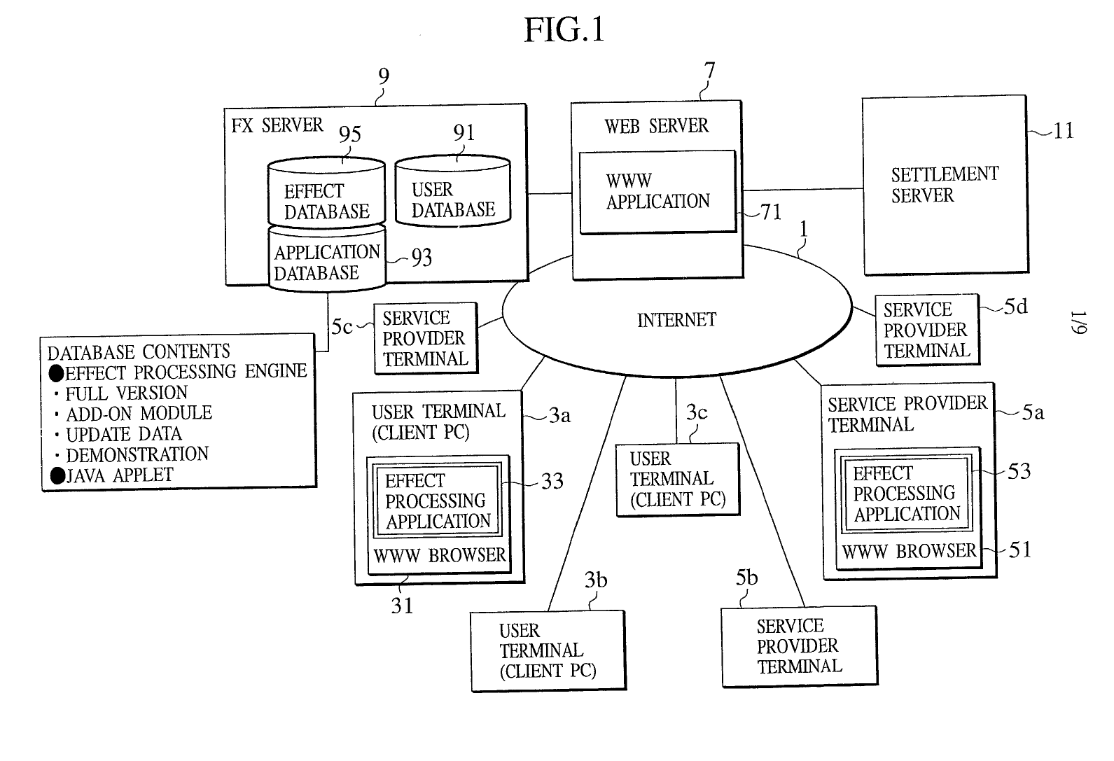

An embodiment according to the present invention will be described below with reference to the drawings. FIG. 1 is a diagram showing the configuration of a system which performs, on a network, digital data effect processing method used in the embodiment of the present invention. As shown in the figure, an FX server 9 acting as an effect server is connected to the Internet 1 via a web server 7. A settlement server 11 is connected to the Internet 1 via the web server 7. Also connected to the Internet are user terminals 3a-3c, which are a plurality of client personal computers (PC), and a plurality of service provider terminals 5a-5d. Note that the settlement server 11 may also be connected to the Internet 1 via the FX server 9.

The web server 7 has a WWW application 71 that provides HTML data (web page data) displayable by a WWW browser 31. The FX server 9 is connected to the Internet 1 via the WWW application 71. The FX server 9 has three databases: a user database 91 in which history data on user terminals 3 is stored, an application database 93 in which effect processing applications such as an effect engine and other applications such as Java applets are stored, and an effect database 95 in which effect data used for effect processing applications is stored.

The digital data effect processing system for use on a network in this embodiment, shown in FIG.1, provides each user terminal 3 with digital data effect processing over the Internet 1. More specifically, the system downloads an effect processing application stored in the application database 93 in the FX server 9 from the web server 7 to the user terminal 3 via the Internet 1. With the downloaded effect processing program, the user terminal 3 performs effect processing for digital data, such as image data, saved therein. As shown in FIG. 1, an effect processing application 33 downloaded from the FX server 9 is installed in the WWW browser 31 in a user terminal 3a.

With the WWW browser 31, the user terminal, 3a, 3b, or 3c, accesses the specified web server 7 to read the effect processing application 33, especially a Java applet, from the application database 93 in the FX server 9. The Java applet is an application used by the WWW browser 31 for starting the effect engine of the effect processing application 33. Then, the terminal can operate, in the WWW browser 31, the effect processing application 33 that adds effects to digital data. The user terminals 3a, 3b, or 3c accesses, via the web server 7, the effect database 95 in the FX server 9 in which effect data is stored and directly selects an effect. That is, the web server 7 reads the effect selected by the user terminal 3a, 3b, or 3c from the effect database 95 in the FX server and returns the selected effect to the user terminals 3. The user on the user terminal 3a, 3b, or 3c may preview digital data while adding the effect to the digital data owned by the terminal.

Data to which an effect is to be added is, for example, image data generated by a digital camera. Both still image data (display method, coloring, deformation, frame effect, etc.) and moving images may be processed. WAVE data and audio data, such as MIDI data, may also be processed. The effect engine may be recorded on a recording medium, such as a CD-ROM, for distribution.

The service provider terminal 5 is configured basically like the user terminal 3. Like the user terminal 3, the service provider terminal 5 downloads an effect processing application from the FX server 9 via the web server 7. As shown in a service provider terminal 5a, a WWW browser 51 in the service provider terminal 5a contains an effect processing application 53 downloaded from the FX server 9. The user terminal 3 performs effect processing for digital data, such as image data, saved on the terminal itself, while the service provider terminal 5 is a provider's terminal that performs processing in behalf of users. The service provider terminal 5 provides processing services, such as the effect processing and print processing of digital data received from the user terminal 3, in response to a request from the user terminal 3. That is, the service provider terminal 5 obtains user's digital data from the Internet 1 or a recording medium in advance and receives a processing request from the user terminal 3 of the user via the Internet 1. The service provider terminal 5 then adds an effect to the digital data according to the processing request, performs other additional processing, such as printing, for the digital data to which the effect has been added, and returns the digital data to the user.

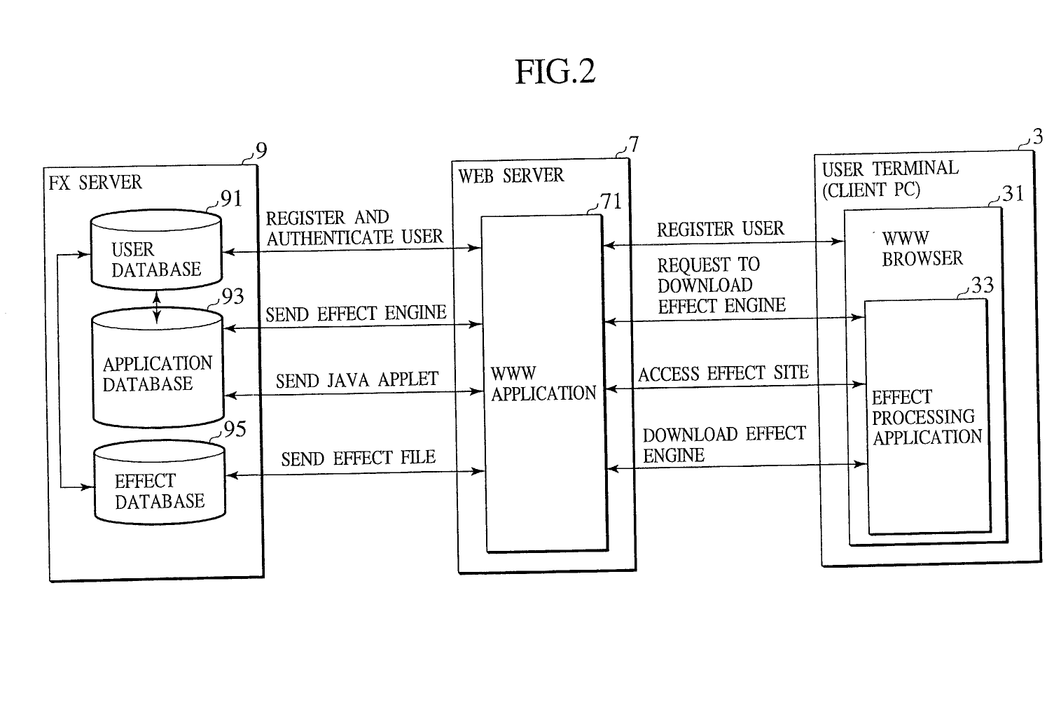

FIG. 2 is a diagram showing the basic processing flow in the digital data effect processing system shown in FIG. 1. As shown in the figure, the user terminal 3 registers itself with the user database 91 in the FX server 9 via the WWW application 71 in the web server 7 before receiving an effect processing application from the FX server 9. For each access, the FX server 9 authenticates the user terminal 3 if it is a registered user terminal.

Once registered, the user terminal 3 sends a download request from the WWW browser 31 to the WWW application 71 in the web server 7 to add an effect to the saved digital data. This download request downloads the effect engine that will constitute the effect processing application. In response to this request, the effect engine is sent from the application database 93 in the FX server 9, and the effect processing application 33 is installed on the user terminal 3. The user terminal 3 uses the WWW browser 31 to access an effect site (web page in which the effect processing contents are prepared) and selects desired effect processing from the effect database 95 in the FX server 9. Then, a Java applet is sent and executed, and the effect file is downloaded onto the user terminal 3.

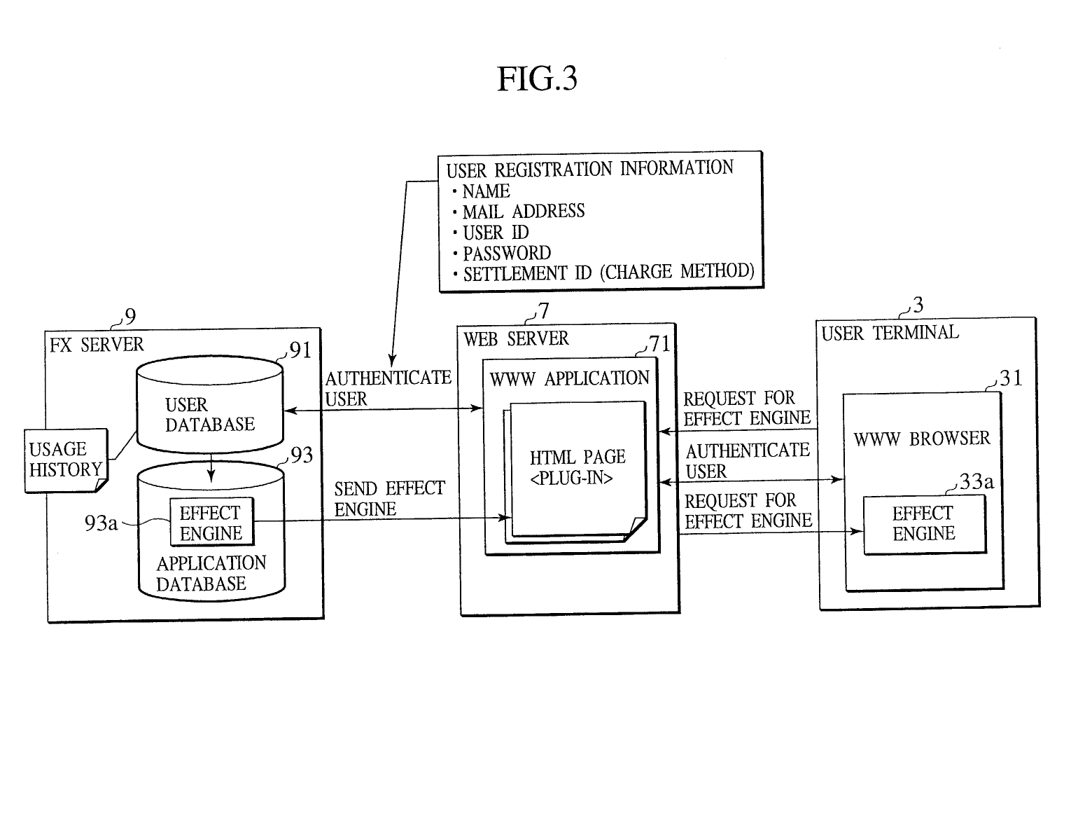

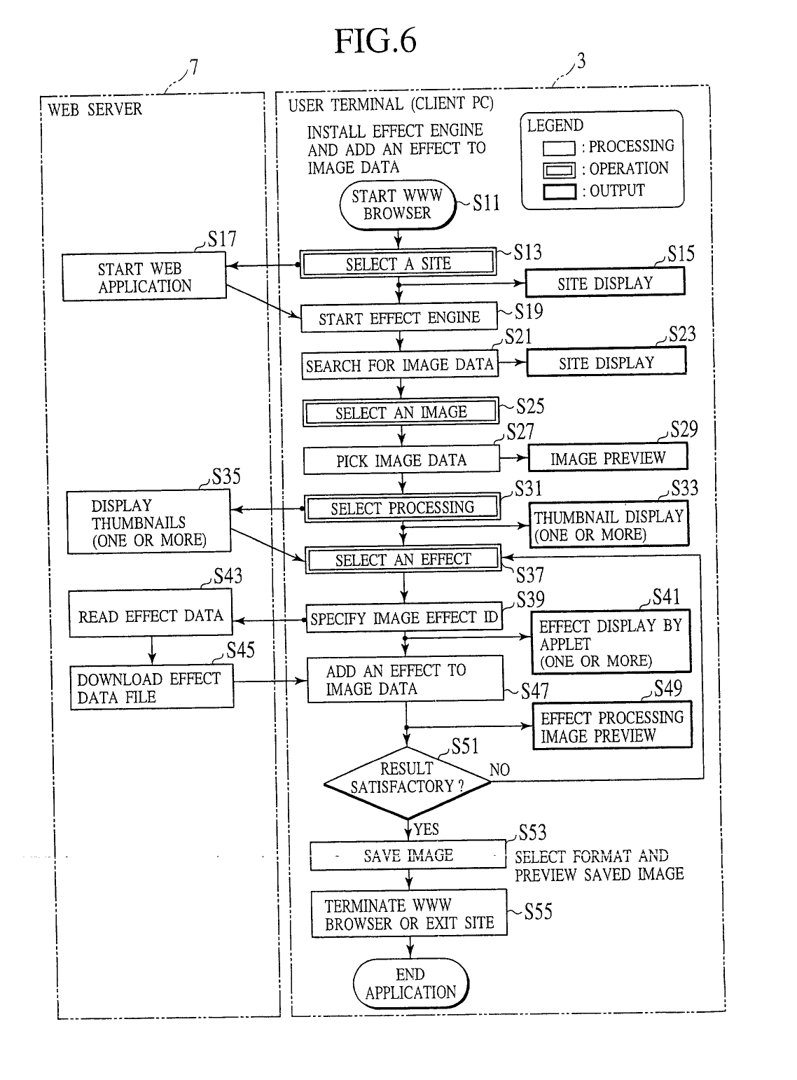

Next, the operation of the embodiment shown in FIG.1 will be described with reference to the sequence diagrams shown in FIGS.3-5 and the flowchart shown in FIG.6.

First, as shown in FIG.3, the user terminal 3 sends an effect engine request from the WWW browser 31 to the FX server 9 via the WWW application 71 in the web server 7. In response to this request, the FX server 9 authenticates the user on the user terminal 3, from which the effect engine request has been sent, to check to see if the user is a registered user. If the user on the user terminal 3 is a registered user, an effect engine 93a stored in the application database 93 in the FX server 9 is downloaded to the user terminal 3 via the WWW application 71. This engine is installed on the user terminal 3 as an effect engine 33a that will be started by the WWW browser 31. Information on the effect engine request from the user terminal 3 and the downloading operation is recorded in the user database 91 as usage history on the user terminal 3.

After the effect engine 33a is downloaded to the WWW browser 31 as described above, the user terminal 3 uses the WWW browser 31 to select a site to access an effect site as shown in the flowchart in FIG. 6. The selected site is then displayed (steps S11, S13, S15). It is assumed, in the flowchart shown in FIG. 6, that the effect engine 33a has already been installed in the WWW browser 31 on the user terminal 3.

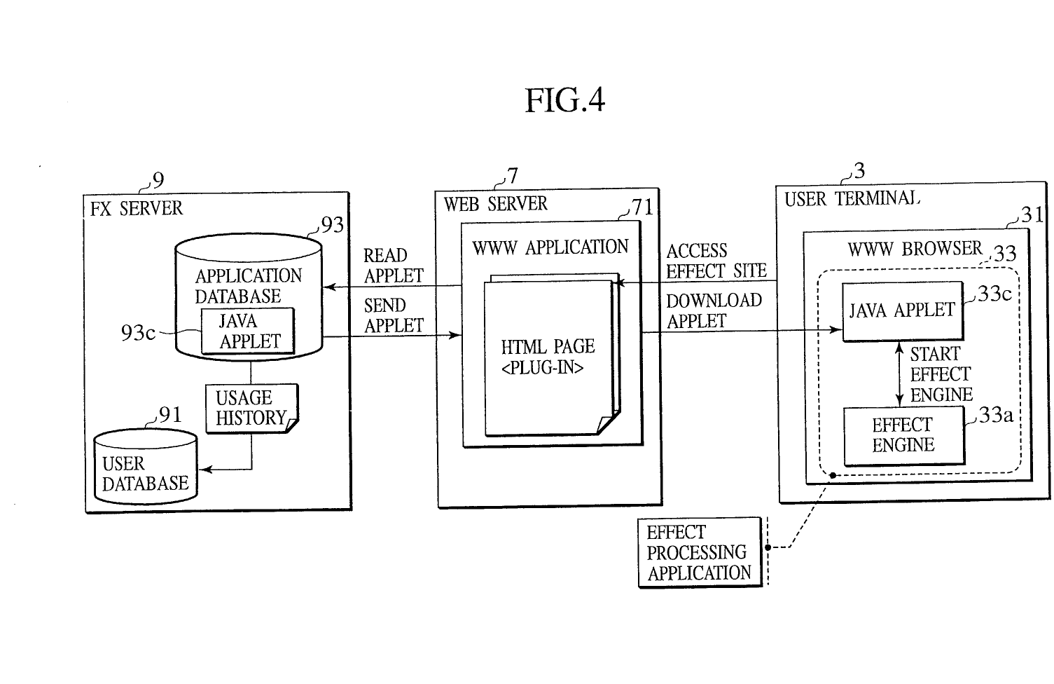

When the user terminal 3 selects a site as shown in FIG. 4, the selected effect site is accessed and the WWW application 71 in the web server 7 is started (step S17). Then, the WWW application 71 reads a Java applet 93c from the application database 93 in the FX server 9. The Java applet 93c read from the application database 93 is sent to the WWW browser 31 in the user terminal 3 via the WWW application 71. This causes the effect engine 33a to be started (step S19). Information on reading and sending the Java applet is serially recorded in the user database 91 as usage history of the user terminal 3.

When the effect engine 33a installed in the user terminal 3 is started, digital data such as image data to which an effect is to be added on the user terminal 3 is retrieved from displayed thumbnails (steps S21 and S23). The user selects an image to which an effect is to be added (step S25). The selected image data is picked for preview (steps S27 and S29).

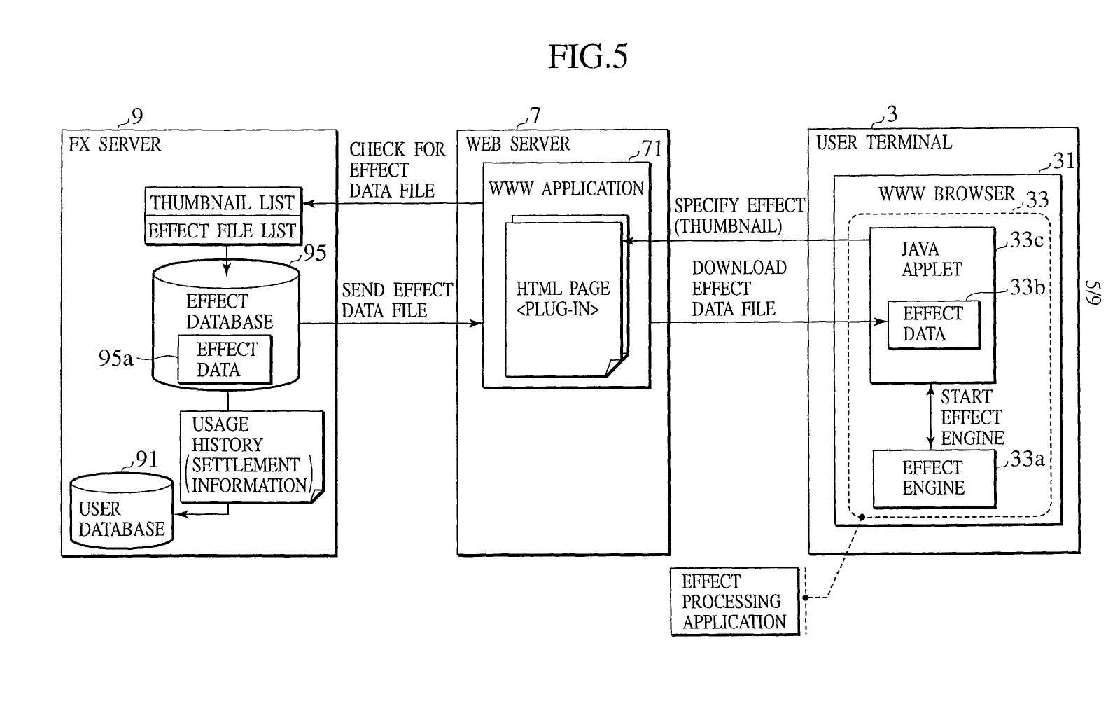

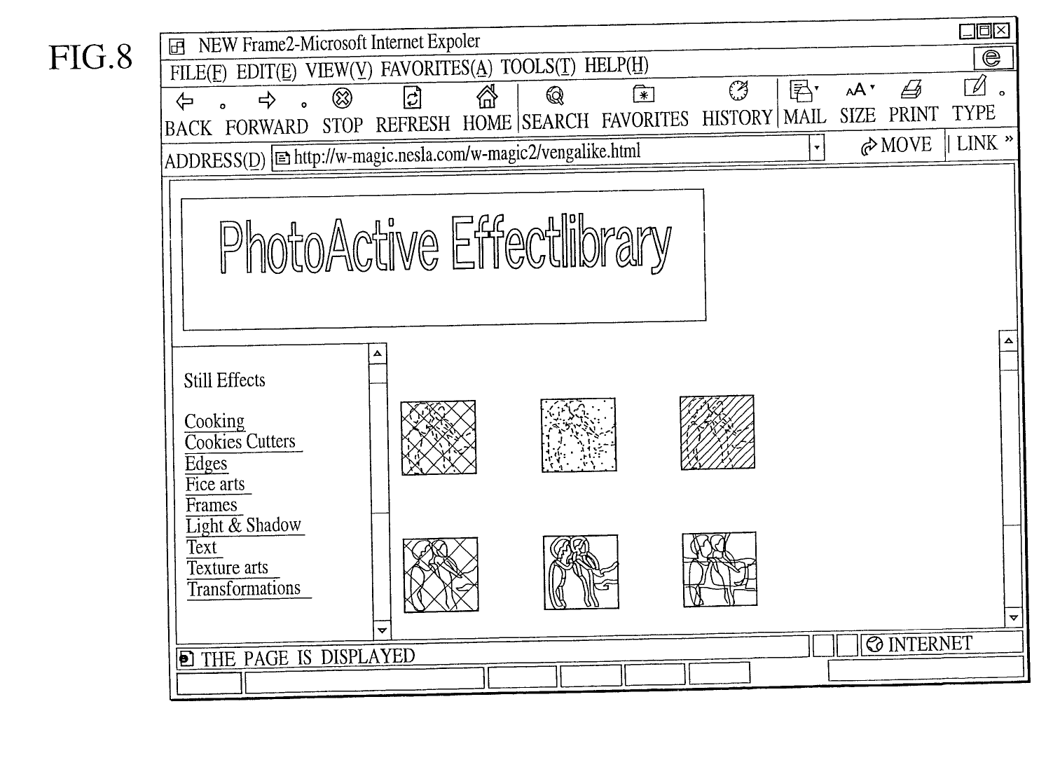

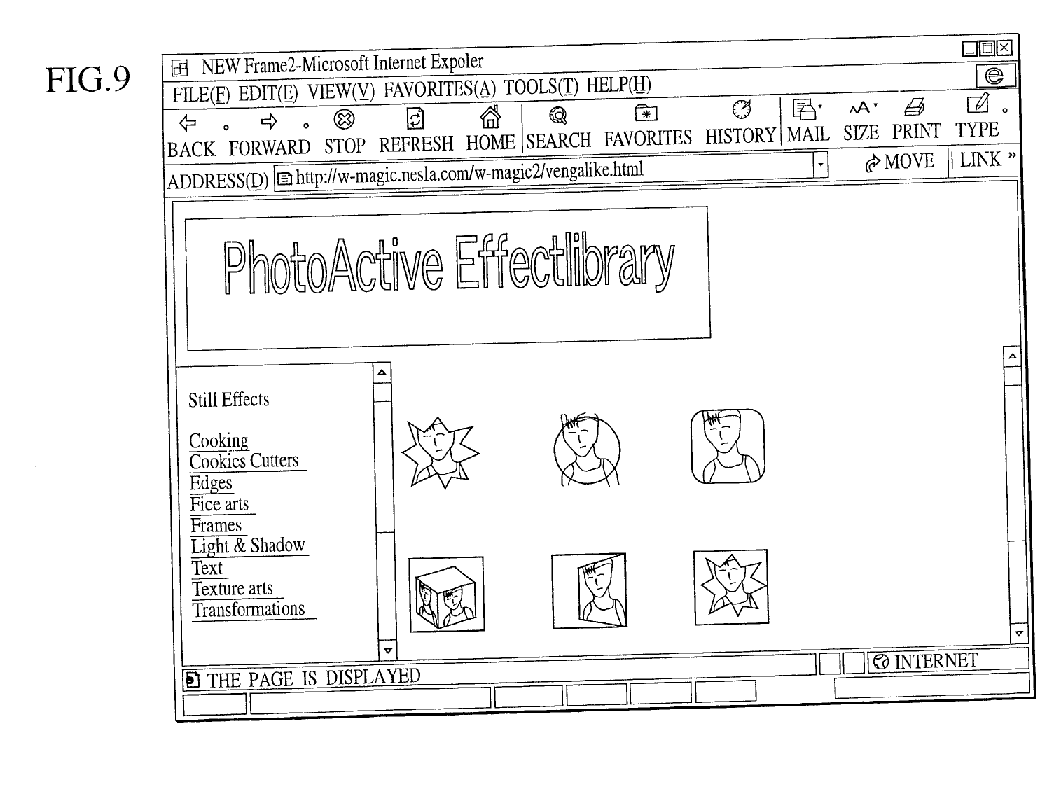

After selecting the image to which an effect is to be added, the user selects an effect type that will be applied to the image (step S31) as shown in FIG. 5. To help the user select an effect type, a plurality of thumbnails indicating the processing contents of the effects included in the selected category are displayed on the screen, such as those shown in FIG.8 and 9, with the effect processing categories on the left (steps S33 and S35). FIG. 9 shows some thumbnails. In the center of the screen in FIG. 9, the star, circle, and rectangle frames are displayed as examples of thumbnails with other effect processing contents below them.

When the user selects a desired effect from the plurality of effects displayed as thumbnails (step S37), the corresponding effect contents are read with the ID of the selected effect specified (step S39). This specified effect is displayed on the user terminal 3 as the selected effect (step S41). In addition, this effect specification information is sent to the WWW application 71 in the web server 7. Upon reception of this information, the WWW application 71 searches the FX server 9 for the effect data file and reads the corresponding effect data 95a from the effect database 95 (step S43). This effect data file is downloaded to the user terminal 3 (step S45) and then stored on the user terminal 3 as effect data 33b. Information on the downloading of the effect data file is recorded in the user database 91 as the usage history information on the user terminal 3.

Once the effect data 33b is stored on the user terminal 3, the effect processing application 33 composed of the already-stored effect engine 33a and a Java applet 33c performs effect processing for the image data selected by the user terminal 3. This allows the user to preview the image to which the effect has been added (steps S47, S49).

The user on the user terminal 3 browses the previewed image, to which the effect has been added, to check to see if the result of effect processing is satisfactory (step S51). If the result of effect processing is unsatisfactory, the user cancels the current effect processing to return control to step S37 to repeat the same processing beginning with the selection of an effect. If the result of effect processing is satisfactory, the user saves the image in a recording medium such as a hard disk (step S53). Then, the user terminates or exits the WWW browser 31 to end the effect processing application (step S55).

In the processing shown in FIG.6, an image to be processed is selected in step S25, and an effect to be added is selected in step S37. This sequence may be reversed. That is, an effect may be selected first (steps S31-S45) and then an image may be selected (step S21-S29).

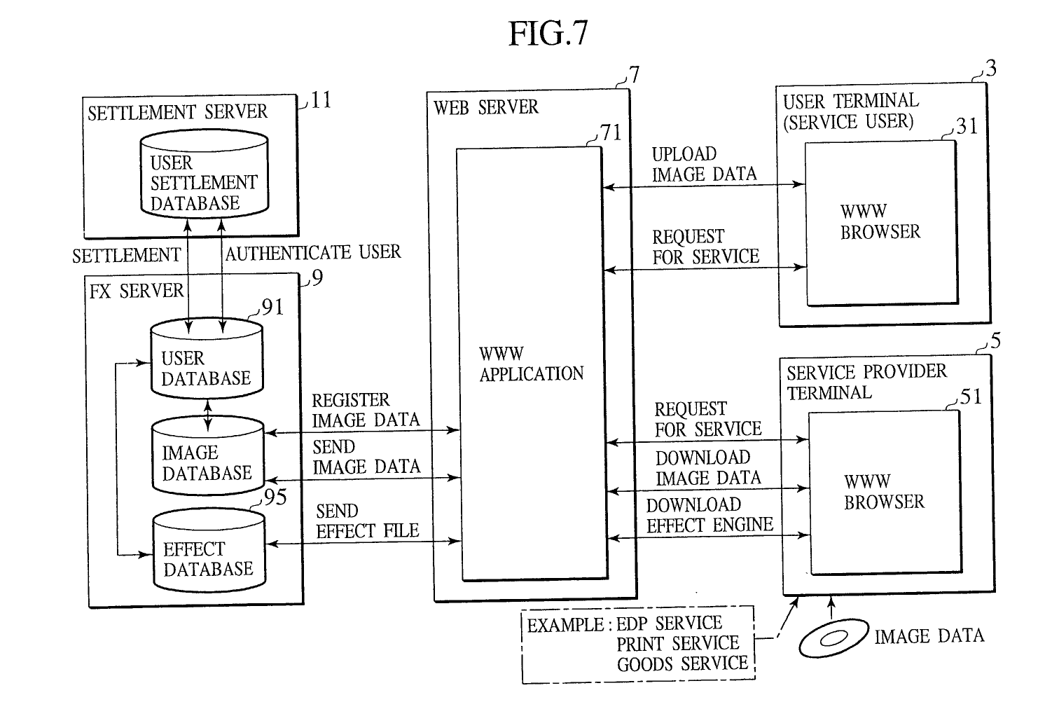

Next, referring to FIG. 7, an example of service provided in this embodiment will be described. As described above, the user terminal 3 accesses the FX server 9 via the WWW application 71 in the web server 7, downloads an effect processing application from the FX server 9, and adds an effect to image data owned by the user terminal 3. The service provider terminal 5 also accesses the FX server 9 via the WWW application 71 in the web server 7, downloads an effect processing application from the FX server 9, and adds an effect to image data, as described above. A difference between these two terminals is that the service provider terminal 5 performs effect processing in response to a request from one of the user terminals 3. Another difference is that the service provider terminal 5 performs not only effect processing but also EDP service, print service, and goods service for image data supplied from the user terminal 3 according to the request.

That is, the user terminal 3 uploads image data, to which an effect has been added as described above, to the WWW application 71 in the web server 7. At the same time, the user terminal 3 sends a service request for processing to be executed for this image data, such as a print service request, to the WWW application WWW application 71 in the web server 7 as shown in FIG. 7. In response to this service request, the WWW application 71 sends a service request, such as a print service request, to the WWW browser 51 in the service provider terminal 5. At the same time, the WWW application 71 downloads the image data, which has been received from the user terminal 3, to the service provider terminal 5. Upon receiving this service request, the service provider terminal 5 performs services, such as a print service, for the image data and outputs it.

That is, in response to a request from the user terminal 3, the service provider terminal 5 adds an effect to the digital data using the web server 7 and the FX server 9. At the same time, the service provider 5 performs a specified service, such as a print service, and outputs it.

In the above embodiment, usage history information on the user terminal 3 is serially recorded in the user database 91 in the FX server 9, as described above. To allow the user on the user terminal 3 to easily select frequently-used digital data effect processing types recorded in the usage history information in the user database 91, a “Favorite” folder for each terminal 3 may be created at the site in the web server 7 or the FX server 9.

As described above, when adding an effect to digital data, the user terminal 3 downloads the effect engine and effect data from the FX server 9. Then, using this downloaded effect engine and effect data, the user terminal 3 adds the effect to the digital data. In this case, by allowing the user to use digital data during effect processing only once for the downloaded data, it is possible to require the user to pay for his or her use as a per-usage charge.

In the above embodiment, the effect processing application 33 is composed of the effect engine and the Java applet, and effect processing is executed using data contained in a data file. Therefore, effect processing may be executed for digital data, which is recorded in the user terminal, by downloading only effect data. This means that effect processing is not included as an application software function but is managed as a data file that executes effect processing. Therefore, it is possible to download and save only necessary effect processing data during online time. And, only effect data may be added and deleted easily.

In addition, an effect processing data file recorded in the server and effect processing data information recorded at a site each have their own ID. Thus, the user who makes a service request and the user who receives a service do not have to exchange digital data to which effect processing has been executed. Only service IDs need be exchanged over the network. At this time, digital data to which an effect is to be added, for example, image data generated by a digital camera, is sent from the user terminal 3 to the service provider terminal 5 over the network. Or, digital data, recorded on a recording medium such as a CD-ROM or MO, is passed to the service provider terminal 5 either from an external EDP service shop or directly from the user.

When the user wants to add a plurality of effects, both the effect processing data and the IDs are downloaded to, and an effect ID table is created on, the user terminal. An ID is added to digital data when it is selected by the user. Effect processing for digital data is recorded as a combination of IDs. When the user requests to execute processing at a time, the plurality of effects are added, one at a time.

The processing procedure for the effect processing method described above may be recorded on a recording medium as a program and included in a computer system. The program recorded on a recording medium may be downloaded or installed on a computer system for execution to allow the system to function as an effect processing system executing the effect processing method. This recording medium makes it easy to distribute the program.

As described above, unlike a conventional online image service, the effect processing method according to the present invention eliminates the need for saving image data in a server and downloading when it is needed. Instead, when adding an effect to digital data, the user selects desired effect processing via the network server with digital data on the user terminal to efficiently add an effect to digital data. The user may use a required effect function in the online mode whenever he or she requires. For example, the user may perform online image processing without having to purchase commercial image processing programs. While commercial image processing programs are designed to run on a personal computer, the method according to the present invention provides the user with an effect engine. Activating a Java applet through a WWW browser eliminates the need for commercial programs but allows the user to selectively use only required effect functions prepared on the network. This reduces the load of the user terminal. The method may also be used on an online-connectable terminal capable of capturing an image, for example, on a CCD-camera-mounted cellular phone capable of accessing a web server. Another advantage is that a user terminal may select a plurality of digital data units to which effects are to be added to allow the effects to be added to those data units in parallel.

It should be understood that many modifications and adaptations of the invention will become apparent to those skilled in the art and it is intended to encompass such obvious modifications and changes in the scope of the claims appended hereto.

What is claimed is:

1. A digital data effect processing method for use on a network for adding, via the network, an effect to digital data saved on a user terminal,
wherein an effect server is connected to the network via a web server, said effect server comprising a processing program adding the effect to the digital data, a calling program running in a WWW browser for calling said processing program, and a plurality of effect data pieces each corresponding to one of a plurality of effect processing types, said method comprising the steps of:
starting the WWW browser in said user terminal to download said processing program stored in said effect server to said user terminal via the network and said web server;
reading said calling program stored in said effect server and sending the calling program to the WWW server in said user terminal;
reading and starting said processing program by said calling program;
selecting one of the plurality of effect data pieces by said processing program;
downloading the selected effect data piece to said user terminal by said processing program; and
on said user terminal, adding the effect to the digital data, to which the effect is to be added, by said processing program using the selected effect data.

2. A digital data effect processing system for use on a network for adding, via the network, an effect to digital data saved on a user terminal, comprising:
an effect server comprising a processing program adding the effect to the digital data, a calling program running in a WWW browser for calling the processing program, and a plurality of effect data pieces each corresponding to one of a plurality of effect processing types;
a web server connected to said effect server and having a WWW application providing data displayable by the WWW browser in the terminal connected via the network; and
said user terminal storing therein the WWW browser and connected to said web server via the network using the WWW browser,
wherein said user terminal starts the WWW browser to download said processing program stored in said effect server and, at the same time, downloads said calling program to start said processing program, and
wherein said processing program selects one of the plurality of effect data pieces, downloads the selected data piece from said effect server, and adds the effect to the digital data, to which the effect is to be added, using the selected effect data.

3. A digital data effect processing system for use on a network, said system adding an effect, over the network, to digital data saved on a service provider terminal in response to a processing request from a user terminal, comprising:
an effect server comprising a processing program adding the effect to the digital data, a calling program running in a WWW browser for calling said processing program, and a plurality of effect data pieces each corresponding to one of a plurality of effect processing types;
a web server connected to said effect server and having a WWW application providing data displayable by the WWW browser in the terminal connected via the network;
said service provider terminal storing therein the WWW browser and connected to said web server via the network using the WWW browser; and
said user terminal sending the effect processing request to said service provider terminal via the network,
wherein said service provider terminal starts the WWW browser in response to the request from said user terminal, downloads said processing program stored in said effect server, and downloads said calling program to start said processing program, and
wherein said processing program selects one of the plurality of effect data pieces, downloads the selected data piece from said effect server, and adds the effect to the digital data, to which the effect is to be added, using the selected effect data.

4. An effect server connected to a network to which a user terminal is connected, comprising:
processing program storing means for storing a processing program which will be downloaded to said user terminal by a WWW browser in said user terminal for adding an effect to digital data saved on said user terminal;
calling program storing means for storing a calling program which will be downloaded to said user terminal for execution in the WWW browser in said user terminal and which calls said processing program; and
effect data storing means for storing a plurality of effect data pieces each corresponding to one of a plurality of effect processing types, one of said plurality of effect data pieces being selected by said processing program and being downloaded to said user terminal.

5. A user terminal connected to a network to which an effect server is connected, comprising:
digital data storing means for storing digital data to which an effect is to be added;
a WWW browser which downloads a processing program stored in said effect server and adding the effect to the digital data and which reads a calling program stored in said effect server to call and start said processing program; and
processing control means for selecting, by said processing program, one of a plurality of effect data pieces each corresponding to one of a plurality of effect processing types, for downloading the selected effect data piece, and for adding the effect to the digital data, to which the effect is to be added, using the selected effect data piece.

6. A recording medium recording therein an effect processing program for use on a network for adding, via the network, an effect to digital data saved on a user terminal, wherein the program causes a computer to:
start a WWW browser stored in said user terminal and connect the WWW browser, via the network, to a web server to which an effect server is connected, said effect server comprising a processing program adding the effect to the digital data, a calling program running in the WWW browser for calling said processing program, and a plurality of effect data pieces each corresponding to one of a plurality of effect processing types;
download said processing program stored in said effect server to said user terminal via the network and the web server;
read said calling program stored in said effect server and send the calling program to the WWW browser in said user terminal;
read said processing program by said calling program to start said processing program;
select one of the plurality of effect data pieces by said processing program;
download the selected effect data piece to said user terminal by said processing program; and
add, on said user terminal, the effect to the digital data by said processing program using the selected effect data piece.

7. A recording medium recording therein an effect processing program for use in an effect server connected to a network to which a user terminal is connected, wherein the program causes a computer to:
download a processing program to said user terminal via the network in response to a request from said user terminal, said processing program adding an effect to digital data;
send a calling program to a WWW browser stored in said user terminal in response to a request from said user terminal, said calling program running in the WWW browser and calling said processing program; and
download one of a plurality of effect data pieces, each corresponding to one of a plurality of effect processing types, to said user terminal according to a selection made by said processing program on said user terminal.

8. A recording medium recording therein an effect processing program for use on a user terminal connected to a network to which an effect server is connected, wherein the program causes a computer to:
start a WWW browser and download a processing program via the network, said processing program being stored in said effect server and adding an effect to digital data;
read a calling program and receive the calling program in the WWW browser, said calling program being stored in said effect server and running in the WWW browser to call said processing program;
read and start said processing program by said calling program;
select one of a plurality of effect data pieces by said processing program, said plurality of effect data pieces being stored in said effect server and each of said plurality of effect data pieces corresponding to one of a plurality of effect types;
download the selected effect data piece from said effect server by said processing program; and
add the effect to the digital data, to which the effect is to be added, by said processing program using the selected effect data piece.
